(19) United States
(12) Patent Application Publication
(10) Pub. No.: US 2008/0222155 A1
(43) Pub. Date: Sep. 11, 2008

(54) METHOD AND APPARATUS FOR PARTIAL PUBLICATION AND INVENTORY MAINTENANCE OF MEDIA OBJECTS IN A REGION

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/683,765

(22) Filed: Mar. 8, 2007

(51) Int. Cl. G06F 17/30

(52) U.S. Cl. 707/10

(57) ABSTRACT

Methods, apparatuses, and articles for regional and enterprise servers in a media object partial publication and inventory maintenance system are described herein. In various embodiments, a regional server may repeatedly request and receive, from an enterprise server, media objects of a collection of media objects based on actual and/or perceived demand, achieving a partial publication of the collection of media objects. Also, the regional server may monitor a physical inventory associated with a media object and, when the inventory falls below a threshold, facilitate the creation of additional physical inventory using the media object. Additionally, the regional server may notify the enterprise server of the creational of inventory to facilitate the enterprise server in acquiring digital rights associated with the media object.

### TECHNICAL FIELD

Embodiments relate to the field of data processing, in particular, to methods and apparatuses for partial publication of a collection of media objects to a regional server and inventory maintenance of media objects on the regional server.

### BACKGROUND

Continuous advancements in processor, storage, networking, and multimedia technologies have led to the wide availability of media objects of many types on demand, deliverable through many types of computing devices over the Internet and other networks. Facilities for users to sample media objects, such as audio clips of songs and movie trailers, are also well known. Such facilities are often provided via software on user computing devices and through computing systems at merchant locations, such as music kiosks. To provide clips or trailers corresponding to a vast catalogue of media objects, however, a merchant having such a kiosk/computer system often must store media objects corresponding to the vast catalogue, thus requiring a massive amount of storage space.

Additionally, merchants often must deal with the problems associated with maintaining an appropriate physical inventory associated with media objects listed in the catalogue. Demand for a given media object may vary from location to location, leading to harmful shortages and surpluses of the media object within locations.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flow chart view of selected operations of the methods of various embodiments of the present invention; and

FIG. 3 illustrates an example computer system suitable for use to practice various embodiments of the present invention.

### DETAILED DESCRIPTION OF ILLUSTRATIVE EMBODIMENTS

Illustrative embodiments of the present invention include, but are not limited to methods and apparatuses for regional and enterprise servers in a media object partial publication and inventory maintenance system. In various embodiments, a regional server may repeatedly request and receive, from an enterprise server, media objects of a collection of media objects based on actual and/or perceived demand, achieving a partial publication of the collection of media objects. Also, the regional server may monitor a physical inventory associated with a media object and, when the inventory falls below a threshold, facilitate the creation of additional physical inventory using the media object. Additionally, the regional server may notify the enterprise server of the creational of inventory to facilitate the enterprise server in acquiring digital rights associated with the media object.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

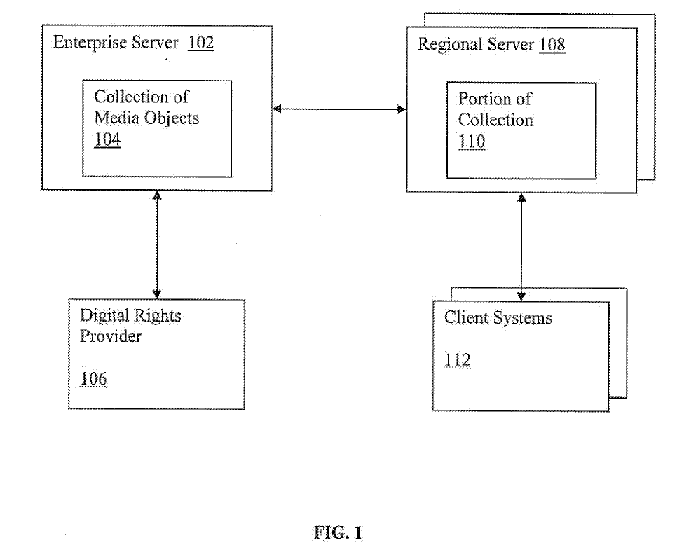

FIG. 1 illustrates an overview of various embodiments of the present invention. As illustrated, an enterprise server 102 may publish media objects from a collection of media objects to one or more regional servers 108, the regional servers 108 each requesting a portion of the collection of media objects 110 based on actual and/or perceived demand within a region having that regional server 108. Thus, each regional server 108 is required to store only a portion of the collection 110, that portion changing dynamically over time in response to repeated requests and receipts by each regional server 108. The regional servers 108 may also monitor physical inventories, associated with ones of the media objects 110, in their respective regions, and may facilitate the generation of additional physical inventory. In response to the creating of additional inventory, or prior to doing so, each regional server 108 may request that the enterprise server 102 acquire digital rights to the additional items of physical inventory. Enterprise server 102 may then acquire digital rights from a digital rights provider 106. In various embodiments, regional servers 108 may also provide clips/trailers of media objects 110 to client systems 112, such as user computing devices in the regions of servers 108 or kiosks of a merchant having the regional servers 108. Also, enterprise server 102, digital rights provider 106, regional server 108, and client systems 112 may be connected by one or more networking fabrics.

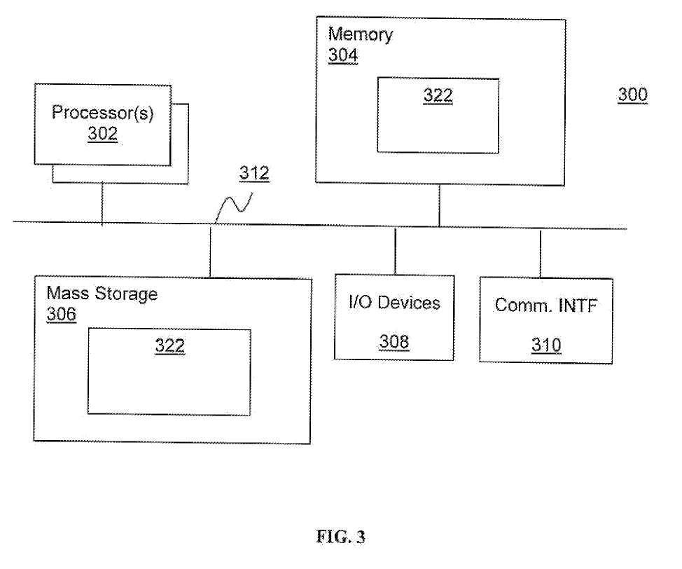

In various embodiments, each of enterprise server 102, digital rights provider 106, and/or client systems 112, and/or each of regional servers 108 may be any single- or multi-processor or processor core central processing unit (CPU) computing system. Enterprise server 102, digital rights provider 106, regional servers 108, and/or client systems 112 may be personal computers (PC), workstations, servers, routers, mainframes, modular computers within a blade servers or high-density servers, personal digital assistants (PDA), entertainment centers, set-top boxes, or wireless mobile devices. In some embodiments, each of enterprise server 102, digital rights provider 106, and/or client systems 112, and/or each of regional servers 108 may also include a networking interface (not shown) that may be used to communicate with each other and with other computing devices. An exemplary single-/multi-processor or processor core computing system of enterprise server 102, digital rights provider 106, regional servers 108, and/or client systems 112 is illustrated by FIG. 3, and is described in greater detail below. Hereinafter, including in the claims, processor and processor core shall be used interchangeable, with each term including the other.

In some embodiments, enterprise server 102, digital rights provider 106, regional servers 108, and/or client systems 112 may be connected by one or more networking fabrics. The networking fabrics may be any sort of networking fabrics known in the art, such as one or more of local area networks (LAN), wide area networks (WAN), and the Internet. In various embodiments, the networking fabric connecting the enterprise server 102 and the regional servers 108, or the regional servers 108 and the client systems 112 may comprise a private LAN or WAN of an enterprise. The parties to the connection may further use any communication protocol known in the art, such as the Hypertext Transfer Protocol (HTTP), and any transport protocol known in the art, such as the Transmission Control Protocol/Internet Protocol (TCP/IP) suite of protocols. As mentioned, each of enterprise server 102, digital rights provider 106, and/or client systems 112, and/or each of regional servers 108 may have a networking interface to facilitate networked communication across some or all of the one or more networking fabrics.

As is shown, enterprise server 102 may be communicatively coupled to one or more regional servers 108 and a digital rights provider 106. And as is described in greater detail above, enterprise server 102 may be any sort of computer system known in the art (except for the below described logic), and may be capable of connecting to other computer systems through one or more networking fabrics. In one embodiment, enterprise server 102 may be a media and digital rights server for an enterprise, such as a retailer, providing media objects to and acquiring digital rights on behalf of regional servers 108 at stores of the enterprise/retailer.

As is further shown, enterprise server 102 may have a collection of media objects 104. Collection 104 may include any sort of media objects known in the art, such as movie files, song files, clip/trailer files corresponding to ones of the movies/songs, television program files, and other audio, visual, and/or audio-visual files. The size and contents of the collection 104 may vary based on the needs of the enterprise of enterprise server 102, and in some embodiments, based on the actual or perceived demand of stores having regional servers 108. The media files of collection 104 may be stored on storage locally available to the enterprise server 102 in any audio/visual format known in the art. In one embodiment, enterprise server 102 may also have a catalogue of media objects. The catalogue may list the collection of media objects 104, or may even list all media objects available for enterprise server 102's acquisition, including collection 104. The catalogue may also be locally available to enterprise server 102 or may be accessible by server 102 through over a network.

Referring again to enterprise server 102, server 102 may provide an initial portion 110 of collection 104 to regional servers 108 prior to receiving any requests from servers 108. The portions provided may be the same for each regional server 108, or may vary from regional server to regional server 108 based on, for example, marketing data. In some embodiments, the portion 110 may comprise only movie, song, and television program files, and in other embodiments, portion 110 may additionally include clips/trailers of those files. This initial portion 110 may be provided by server 102 the very first time a regional server 108 registers with enterprise server 102. In one embodiment, enterprise server 102 may also provide each regional server 108 with the above described catalogue to facilitate regional servers 108 in requesting media objects.

Subsequently, in various embodiments, enterprise server 102 may receive repeated requests from regional servers 108 for media objects of collection 104. Each request may be made by a regional server 108 in response to actual or perceived demand in the store/region having the server 108. In some embodiments, enterprise server 102 may receive requests for media objects that are present in the catalogue but not in collection 104. In response to such requests, enterprise server 102 may acquire the media objects from another system and add them to collection 104. In various embodiments, upon receiving a request for media objects, enterprise server 102 may provide the requested media objects to the regional servers 108. In one embodiment, in addition to providing the requested media objects, server 102 may also automatically provide clips/trailers corresponding to the requested media objects. Also, in various embodiments, enterprise server 102 may periodically assemble a list of requested objects and the regions/locations requesting them, and may provide this list to regional servers 108 with the requested media objects, facilitating the regional servers 108 in determining perceived demand.

In some embodiments, enterprise server 102 is capable of acquiring digital rights to media objects. Server 102 may acquire digital rights prior to providing portions 110 to regional servers 108, or later, upon receiving notification from servers 108 of an increase in physical inventory corresponding to media objects. In one embodiment, upon first receiving a media object of collection 104, server 102 may acquire a license or other digital rights from digital rights provider 106, the license or digital rights permitting server 102 to distribute the media object to regional servers 108 and permitting creation of physical inventory associated with the media object. The license/digital rights may allow the creation of a limited or unlimited amount of physical inventory. In other embodiments, server 102 may acquire digital rights/licenses after the creation of physical inventory corresponding to a media object. In such embodiments, server 102 may receive notifications from servers 108 upon any increase in physical inventory associated with a media object of collection 104. In turn, server 102 may notify rights provider 106, and may acquire rights from rights provider 106.

As illustrated, digital rights provider 106 may be communicatively coupled to enterprise server 102 and may acquire or provide digital rights to server 102. As described above, digital rights provider 106 may be any sort of computer system known in the art and may be capable of connecting to one or more networks. In some embodiments, provider 106 may actually comprise a plurality of computer systems, with one system coupled to server 102 and adapted to acquire rights on behalf of server 102, and with another system coupled to the rights acquiring system, the other system providing the digital rights. Rights provider 106 may be provide digital rights to server 102 in response to server 102 requests. In one embodiment, provider 106 may also provide media objects along with the digital rights, creating or enhancing collection 104. Digital rights and/or media objects may be provided upon receiving either compensation or an enforceable promise to pay compensation from server 102. The digital rights provided may include licenses to sell, distribute, and reproduce media objects, and many include any other form of rights known in the art.

As illustrated, one or more regional servers may be communicatively coupled to enterprise server 102 and client systems 112. And as described above, each regional server 108 may be any sort of computer system known in the art and may be capable of connecting to one or more networks. In some embodiments, each regional server 108 may be associated with a store or some physical location offering the media objects 110 in digital or physical form. Each store/location of each server 108 may be associated with the same enterprise having enterprise server 102, or may be associated with differing enterprises subscribing to a service offered by the enterprise of enterprise server 102. In some embodiments, regional server may alternatively or additionally be associated with a region, which may include or be the same as a store/location. Client systems 112 in the region of regional server 108 may be communicatively coupled to it. The size of the region of regional server 108 may vary based on the size of the enterprise, the relative distances between stores, and the technology and needs of the enterprise. As described further below, if the region includes or is a store, some or all of client systems 112, may be store kiosks.

In various embodiments, a portion 110 of the collection of media objects 104. The types and formats of media objects are described above in further detail. Portion 110 may represent media objects of the collection 104 that are most in demand in the region. The portion 110 may be limited in size by locally available data storage or by a policy which allows local storage of at most a specific number of media objects (e.g., one hundred objects that are actually or are perceived to be the most in demand). In some embodiments, clips and trailers for every media object in collection 104 may be stored on server 108, even though only a portion 110 of the media objects are actually stored. Upon determining a change in demand, additional media objects may be requested, and other media objects may be deleted from local storage, thus maintaining a partial publication of media objects of collection 104 on each regional server 108.

Referring again to regional servers 108, each regional server 108 may receive an initial portion 110 of media objects upon first registering with enterprise server 102. As is discussed in greater detail above, this initial portion may be determined by enterprise server 102, and may be the same or different for each regional server 108. In some embodiments, while registering with server 102, a regional server 108 may indicate preferences corresponding to actual or perceived demand for media objects in the region, and an initial portion 110 may be created and customized for server 108 by server 102 based on these preferences. Upon receiving the initial portion 110, each regional server 108 may store the portion 110 in locally available storage. Also, in various embodiments, enterprise server 102 may provide regional servers 108 with a catalogue including all available media objects in collection 104, the catalogue discussed in greater detail above.

In various embodiments, as actual and/or perceived demand for media objects change in a region, a regional server 108 may request additional media objects from enterprise server 102. The regional server may be made aware of the additional media objects by the catalogue of the collection 104. Actual demand for a media object may be determined in any number of ways known in the art. In some embodiments, regional servers 108 may receive indicia of actual demand from one or more client systems 112 and/or sales systems of the store/region. Such indicia may include at least one of media object sales and listens or views of media objects on a client system 112. Perceived demand may correspond to a judgment of personnel associated with a store having a regional server 108 as to which media objects are likely to be of interest in the store/region. Perceived demand may also correspond to information received from enterprise server 102 regarding sales or other demand indicia from other areas. Personnel reviewing such information may determine that another region is substantially similar to his/her region and may perceive demand for a media object based on the other region's demand for the media object. Upon determining the existence of a new perceived demand or other change in actual demand, a regional server 108 may re-prioritize, comparing the new demand to demand for locally available media objects of portion 110. The media objects of portion 110 having the least demand may then be deleted from local storage if storage size or a policy requires it, as described above. In various embodiments, regional server 110 may then request the media objects from the enterprise server 104.

In some embodiments, the requesting regional server 108 may then receive the requested media objects from enterprise server 102, as discussed above. Regional server 108 may then store the received media objects in locally available storage, adding the objects to portion 110. Portion 110 may remain the same then, until a change in actual or perceived demand, at which point the above described media object requesting and receiving may be repeated.

In various embodiments, regional servers 108 may also be adapted to maintain a physical inventory associate with media objects of portion 110 in their respective stores/regions. In one embodiment, upon first receiving a new media object, regional server 108 may facilitate personnel of the store/region in creating physical inventory with the new media object. Physical inventory may comprise one or more media storage devices known in the art, such as DVDs and/or CDs. Personnel associated with the store/region of the regional server may create the inventory by storing the media object onto the storage devices. The quantity of such created physical inventory may correspond to actual or perceived store/region needs. In some embodiments, regional server 108 may also be equipped to monitor the quantity of physical inventory and to alert the personnel if the quantity falls below a pre-defined threshold. Information regarding sales of physical inventory received, for example, from client systems 112 and/or sales systems of the store/region may inform the monitoring by server 108. Upon providing personnel with an alert through, for example, an email or a pop up on a display of a computer system of the store/region, regional server 108 may facilitate personnel in creating additional physical inventory in the same manner as described above for creating initial inventory, the physical inventory to be available for purchase.

In some embodiments, upon creating new physical inventory of a media object, regional server 108 may notify enterprise server 102 of the creation of the physical inventory, as well as the quantity of inventory created, to facilitate the enterprise server 102 in acquiring digital rights associated with the new inventory. The acquisition and types of digital rights are described in greater detail above.

Further, as is shown, regional servers 108 may provide client systems 112 with clips and/or trailers corresponding to portion of media objects of portion 110. These clips/trailers may be media objects in their own right, received from enterprise server 102, or may be dynamically derived by regional servers 108 from media objects of portions 110. Such clips/trailers may be dynamically derived in any manner known in the art, including selecting the “beginning” of the media object (e.g., the first thirty seconds, first minute, etc.). The received and/or derived clips/trailers may then be provided to client systems 112. In some embodiments, regional servers 108 may also provide client systems 112 with the catalogue of collection 104 to facilitate systems 112 in requesting clips/trailers that are not present on client systems 112 and regional server 108. In response, regional server 108 may request the clips/trailers from enterprise server 102, may receive and them it/them to portion 110, and may provide the clips/trailers to client systems 112.

Also, in one embodiment, client systems 112 may be able to purchase media objects of portion 110 or corresponding inventory, and regional servers 108 may receive requests for purchased media objects from client systems 112, or receive inventory purchase notifications, and in turn notify personnel to reserve an item of the physical inventory.

As is further illustrated, one or more client systems 112 may be communicatively coupled to a regional server 108. As described above, client systems 112 may be any sort of computer system known in the art and may be capable of connecting to one or more networks. Client systems 112 may include, in some embodiments, one or both of kiosks in a store having regional server 108 and/or mobile devices located in a region having the regional server. Client systems 112 may either store, or retrieve on demand, clips and/or trailers corresponding to media objects. Clips/trailers may correspond only to media objects of portion 110, to media objects 104, or, if the catalogue contains media objects that are not part of collection 104, those media objects as well. In some embodiments, where client systems 112 store the clips/trailers, the client systems 112 may periodically receive clips and/or trailers from server 108. In one embodiment, server 108 determines which clips/trailers will be provided to client systems 112. Server 108 may also provide the catalogue to client systems 112, to allow users of client systems 112 to request clips and/or trailers from the catalogue that are not stored on client systems 112.

In some embodiments, client systems 112 may facilitate users in acquiring a media object corresponding to a clip or trailer. Client systems 112 may facilitate the acquisition by retrieving the actual media object and allowing users to transfer the object to another client device or to store the media object on a physical medium, such as a DVD or CD, in response to payment or promise of payment received from a user. In other embodiments, client systems 112 may facilitate acquisition of the of the media object by reserving physical inventory associated with the object at a store having the client system 112 or in the same region as the client system 112.

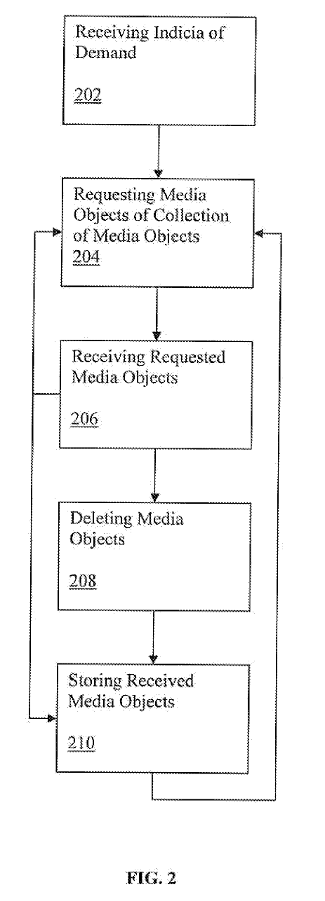

FIG. 2 illustrates a flow chart view of selected operations of the methods of various embodiments of the present invention. As illustrated, a regional server having a portion of a collection of media objects may receive indicia of actual and/or perceived demand for one(s) of the collection of media objects, block 202. The media objects of the collection may comprise one or more of songs, movies, television programs, audio clips, and/or movie trailers. The indicia may be received from one or more client and/or sales systems of the region having the regional server. Such indicia may indicate actual demand, in the forms of sales or views/listens of a media object. The regional server may also receive indicia of demand in another region, which, if similar to the region having the regional server, may give rise to an inference of perceived demand. Upon receiving the indicia, the regional server may determine whether the demand has changed. If the demand has changed, and an “in-demand” media object of the collection is not locally available to the regional server, the regional server may request the media object from an enterprise/media server having the entire collection of media objects, block 204. In some embodiments, the regional server knows of the media object and requests the object based on a catalogue of the collection of media objects. In response, the regional server may receive the requested media object from the enterprise server, block 206. Further, upon noting a change in demand, regional server may delete one or more media objects from locally available storage based on a perceived or actual lack of demand, block 208. Deletion of such media objects may be required either because of size restraints of locally available storage or because of a policy requiring that a regional server store only the most in-demand media objects (e.g., the “top 100” media objects, as determined by actual and/or perceived demand). Thus, addition of new media objects received from the enterprise server may require deletion of other media objects, thus facilitating a method of partial publication that conserves locally available regional server storage space. Upon receiving the requested media object from the enterprise server, the regional server may store the object in locally available storage, block 210.

In various embodiments, the operations of blocks 202-210 may be repeated as actual and/or perceived demand changes.

FIG. 3 illustrates an example computer system suitable for use to practice various embodiments of the present invention. As shown, computing system 300 includes a number of processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CDROM) and so forth), input/output devices 308 (such as keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing the various components, herein collectively denoted as 322. The various components may be implemented by assembler instructions supported by processor(s) 302 or high-level languages, such as C, that can be compiled into such instructions.

The permanent copy of the programming instructions may be placed into permanent storage 306 in the factory, or in the field, through, for example, a distribution medium (not shown), such as a compact disc (CD), or through communication interface 310 (from a distribution server (not shown)). That is, one or more distribution media having an implementation of the agent program may be employed to distribute the agent and program various computing devices.

The constitution of these elements 302-312 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
requesting, by a regional server, one or more media objects of a collection of media objects based on an actual demand and/or a perceived demand for the one or more media objects within a region, the request being made of a media server having the entire collection of media objects;
receiving, by the regional server, from the media server, the requested media objects; and
repeating said requesting and said receiving in response to a change in the actual and/or perceived demand for a portion of the collection of media objects.

2. The method of claim 1, wherein the one or more media objects comprise at least one of a song, a movie, an audio clip, or a movie trailer.

3. The method of claim 1, further comprising receiving indicia of actual demand from one or more client and/or sales systems of the region.

4. The method of claim 3, wherein the indicia include at least one of media object sales and listens or views of media objects on a client system.

5. The method of claim 1, wherein said requesting comprises requesting one or more media objects listed in a catalogue of the collection of media objects.

6. The method of claim 1, further comprising deleting media objects that are locally available based on an actual and/or a perceived lack of demand.

7. The method of claim 1, further comprising storing the received one or more media objects in locally available storage.

8. The method of claim 1, wherein the perceived demand for the one or more media objects within the region corresponds to actual demand for the one or more media objects in at least one other region.

9. A regional server comprising:
a processor; and
an inventory module operated by the processor and adapted to
monitor a physical inventory corresponding to a media object that is locally available to the regional server to determine whether a count of the physical inventory has fallen below a threshold,
if the count of the physical inventory has fallen below a threshold, notify a user of the count of the physical inventory to facilitate the user in increasing the physical inventory using the locally available media object, and
upon an increase of the physical inventory, notify an enterprise server of the increase in physical inventory to facilitate the enterprise server in obtaining digital rights to the portion of the physical inventory corresponding to the increase.

10. The regional server of claim 9, wherein the media object is one of a song, a movie, and a television program.

11. The regional server of claim 9, wherein the physical inventory includes one or more of CDs and/or DVDs storing the media object.

12. The regional server of claim 9, wherein the inventory module is further adapted to increase the physical inventory, and the increase comprises storing the media object onto one or more CDs or DVDs to be available for purchase.

13. The regional server of claim 9, wherein the digital rights comprise a license to the media object which is associated with each item of the portion of physical inventory corresponding to the increase.

14. The regional server of claim 9, wherein the inventory module is further adapted to receive at least a portion of the count from one or more client and/or sales systems of a region having the regional server.

15. The regional server of claim 9, wherein the inventory module is further adapted to provide a portion of the media object to a client system of a region including the regional server to facilitate the client system in presenting a user with the portion.

16. The regional server of claim 15, wherein the inventory module is further adapted to dynamically generate the portion from the media object.

17. An article of manufacture comprising:
a storage medium; and
a plurality of programming instructions stored on the storage medium and configured to program an apparatus to
receive a request from a regional server for one or more media objects of a collection of media objects, the request based on an actual and/or a perceived demand for the one or more media objects within a region, the regional server having only a portion of the collection of media objects locally available, and the apparatus having the entire collection of media objects locally available, and
provide the one or more media objects to the regional server.

18. The article of claim 17, wherein the one or more media objects comprise at least one of a song, a movies, an audio clip, or a movie trailer.

19. The article of claim 17, wherein the programming instructions are further configured to program an apparatus to, prior to said receive, provide the regional server with an initial portion of the collection of media objects.

20. The article of claim 17, wherein the programming instructions are further configured to program an apparatus to said receive from and said provide to a plurality of regional servers of a plurality of regions, for an enterprise.

21. The article of claim 17, wherein the programming instructions are further configured to program an apparatus to receive notification of creation of physical inventory corresponding to one or more media objects of the collection of media objects, and to acquire digital rights to the created physical inventory.
